(19) United States
(12) Patent Application Publication
(10) Pub. No.: US 2019/0288273 A1
(43) Pub. Date: Sep. 19, 2019

(54) ELECTROLYTE SYSTEMS FOR SILICON-CONTAINING ELECTRODES

(71) Applicant: GM GLOBAL TECHNOLOGY OPERATIONS LLC, Detroit, MI (US)

(72) Inventors: Li Yang, Troy, MI (US); Mark W. Verbrugge, Troy, MI (US); Mei Cai, Bloomfield Hills, MI (US); Meng Jiang, Rochester Hills, MI (US)

(73) Assignee: GM GLOBAL TECHNOLOGY OPERATIONS LLC, Detroit, MI (US)

(21) Appl. No.: 15/924,980

(22) Filed: Mar. 19, 2018

(51) Int. Cl. H01M 4/04; H01M 10/0525; H01M 10/0563

(52) U.S. Cl. CPC H01M 4/0459; H01M 10/0563; H01M 10/0525

(57) ABSTRACT

A method of making an electrochemical cell comprising a silicon-containing anode includes forming a first electrochemical cell comprising the silicon-containing anode and a first electrolyte system, pre-lithiating the silicon-containing anode to produce a pre-lithiated anode in the first electrochemical cell, and forming a second electrochemical cell including the pre-lithiated anode and a second electrolyte system. The first electrolyte system includes a fluorinated solvent in an amount greater than 5 wt % and a first salt; and the second electrolyte system includes a hydrocarbon and a second salt. Forming the second electrochemical cell may include removing the first electrolyte system from the first electrochemical cell and introducing the second electrolyte to the emptied first electrochemical cell; or removing the pre-lithiated anode from the first electrochemical cell and constructing the second electrochemical cell with the pre-lithiated anode and the second electrolyte system.

### INTRODUCTION

This section provides background information related to the present disclosure which is not necessarily prior art.

The present disclosure relates to binary electrolyte systems for electrochemical cells having silicon-containing electroactive material, and methods relating to preparation of electrodes and electrochemical cells including binary electrolyte systems.

By way of background, high-energy density, electrochemical cells, such as lithium ion batteries can be used in a variety of consumer products and vehicles, such as Hybrid Electric Vehicles (HEVs) and Electric Vehicles (EVs). Typical lithium ion batteries comprise a first electrode (e.g., a cathode), a second electrode (e.g., an anode), an electrolyte material, and a separator. Often a stack of lithium ion battery cells are electrically connected to increase overall output. Conventional lithium ion batteries operate by reversibly passing lithium ions between the negative electrode and the positive electrode. A separator and an electrolyte are disposed between the negative and positive electrodes. The electrolyte is suitable for conducting lithium ions and may be in solid or liquid form. Lithium ions move from a cathode (e.g., positive electrode) to an anode (e.g., negative electrode) during charging of the battery, and in the opposite direction when discharging the battery.

Contact of the anode and cathode materials with the electrolyte can create an electrical potential between the electrodes. When electron current is generated in an external circuit between the electrodes, the potential is sustained by electrochemical reactions within the cells of the battery. Each of the negative and positive electrodes within a stack is connected to a current collector (typically a metal, such as copper for the anode and aluminum for the cathode). During battery usage, the current collectors associated with the two electrodes are connected by an external circuit that allows current generated by electrons to pass between the electrodes to compensate for transport of lithium ions.

Many different materials may be used to create components for a lithium ion battery. For example, cathode materials for lithium batteries typically comprise an electroactive material which can be intercalated with lithium ions, such as lithium-transition metal oxides or mixed oxides of the spinel type, for example including spinel LiMn₂O₄, LiCoO₂, LiNiO₂, LiMn_{1.5}Ni_{0.5}O₄, LiNi_{(1-x-y)}CoₓM_{y}O₂ (where 0<x<1, y<1, and M may be Al, Mn, or the like), or lithium iron phosphates. The electrolyte typically contains one or more lithium salts, which may be dissolved and ionized in a non-aqueous solvent. The negative electrode typically includes a lithium insertion material or an alloy host material. For example, typical electroactive materials for forming an anode include lithium-graphite intercalation compounds, lithium-silicon intercalation compounds, lithium-tin intercalation compounds, and lithium alloys.

Certain anode materials have particular advantages. While graphite compounds are most common, anode materials with high specific capacity (in comparison with conventional graphite) are of growing interest. For example, silicon has the highest known theoretical charge capacity for lithium, making it one of the most promising materials for rechargeable lithium ion batteries. However, anode materials comprising silicon may suffer from significant drawbacks. For example, volumetric expansion can lead to loss of electrical contact and electrode activity. This is especially true at the loading density levels required for commercial viability of silicon-containing electrodes.

In certain instances, fluorinated based electrolyte systems have been used to improve cycling performance of silicon-containing anode materials and promote initial formation of protective solid electrolyte interface (SEI) layers. However, lithium ion batteries including such fluorinated based electrolyte systems also have potential downsides in some situations, including gassing. Such gassing may be of particular concern for sealed pouch cells. Accordingly, it would be desirable to develop reliable, high-performance materials for use in high energy electrochemical cells that, for example, allow for use of fluorinated based electrolyte systems in high concentrations and minimize or reduce gassing side reactions thereby similarly suppressing or minimizing negative effects resulting therefrom. For long term and effective use, anode materials containing silicon should be capable of minimal capacity fade and maximized charge capacity for long-term use in lithium ion batteries.

### SUMMARY

This section provides a general summary of the disclosure, and is not a comprehensive disclosure of its full scope or all of its features.

In various aspects, the present disclosure provides a method of making an electrochemical cell that cycles lithium ions. The electrochemical cell may include a silicon-containing anode. The method may include forming a first electrochemical cell that includes the silicon-containing anode and a first electrolyte system; pre-lithiating the silicon-containing anode to produce a pre-lithiated anode in the first electrochemical cell; and forming a second electrochemical cell that includes the pre-lithiated anode and a second electrolyte system. The first electrolyte system may include a fluorinated solvent and a first salt. The fluorinated solvent may be present in the first electrolyte system in an amount greater than about 5 wt %. The second electrolyte system may include a hydrocarbon solvent and a second salt.

In one aspect, forming the second electrochemical cell may include removing the first electrolyte system from the first electrochemical cell and introducing the second electrolyte into the emptied first electrochemical cell.

In one aspect, forming the second electrochemical cell may include removing the pre-lithiated anode from the first electrochemical cell and constructing the second electrochemical cell with the pre-lithiated anode and the second electrolyte system.

In one aspect, the method may further include washing the pre-lithiated anode with the hydrocarbon solvent.

In one aspect, the second electrolyte system may include a residual amount of the fluorinated solvent in an amount less than or equal to about 2 wt %.

In one aspect, the fluorinated solvent may include a solvent selected from the group consisting of: fluoroethylene carbonate (FEC), difluoroethylene carbonate (DFEC), trifluoropropylene carbonate (TFPC), methyl 2,2,2-trifluoroethyl carbonate, ethyl 2,2,2-trifluoroethyl carbonate, 2,2-difluoroethyl methyl carbonate, 2,2-difluoroethyl ethyl carbonate, 2,2-difluoroethylacetate, 2,2,2-trifluoroethylacetate, 1,1,2,2-tatrafluoroethyl 2,2,3,3-tetrafluoropropylether, and combinations thereof; the hydrocarbon solvent may include a solvent selected from the groups consisting of: ethylene carbonate (EC), propylene carbonate (PC), vinylene carbonate (VC), dimethyl carbonate (DMC), ethyl methyl carbonate (EMC), diethyl carbonate (DEC), and combinations thereof; and the first salt and the second salt may be independently selected from the group consisting of: lithium hexafluorophosphate (LiPF₆); lithium bis(fluorosulfonyl)imide (LiN(FSO₂)₂) (LiSFI); lithium bis(oxalato)borate (LiB(C₂O₄)₂) (LiBOB); lithium difluorooxalatoborate (LiBF₂(C₂O₄)); lithium perchlorate (LiClO₄); lithium tetrachloroaluminate (LiAlCl₄); lithium iodide (LiI); lithium bromide (LiBr); lithium thiocyanate (LiSCN); lithium tetrafluoroborate (LiBF₄); lithium tetraphenylborate (LiB(C₆H₅)₄); lithium hexafluoroarsenate (LiAsF₆); lithium trifluoromethanesulfonate (LiCF₃SO₃); bis(trifluoromethane)sulfonimide lithium salt (LiN(CF₃SO₂)₂); and combinations thereof.

In one aspect, the second electrochemical cell may have a Coulombic capacity loss of about 23% after about 500 cycles.

In various other aspects, the present disclosure provides another method of making an electrochemical cell that cycles lithium ions. The electrochemical cell may include an anode including a silicon-containing electroactive material. The method may include introducing a first electrolyte system into the electrochemical cell; cycling the electrochemical cell to pre-lithiate the anode; removing the first electrolyte system from the electrochemical cell; and introducing a second electrolyte system into the electrochemical cell. The first electrolyte system may include a fluorinated solvent and a first salt. The fluorinated solvent may have a concentration in the first electrolyte system of greater than about 0.6 M. The second electrolyte system may include a hydrocarbon solvent and a second salt.

In one aspect, the fluorinated solvent may include a cyclic fluorinated solvent selected from the group consisting of: fluoroethylene carbonate (FEC), difluoroethylene carbonate (DFEC), trifluoropropylene carbonate (TFPC), and combinations thereof.

In one aspect, the fluorinated solvent may include a linear fluorinated solvent selected from the group consisting of: methyl 2,2,2-trifluoroethyl carbonate, ethyl 2,2,2-trifluoroethyl carbonate, 2,2-difluoroethyl methyl carbonate, 2,2-difluoroethyl ethyl carbonate, 2,2-difluoroethylacetate, 2,2,2-trifluoroethylacetate, 1,1,2,2-tatrafluoroethyl 2,2,3,3-tetrafluoropropylether, and combinations thereof.

In one aspect, the hydrocarbon solvent may include a cyclic hydrocarbon solvent selected from the group consisting of: ethylene carbonate (EC), propylene carbonate (PC), vinylene carbonate (VC), and combinations thereof.

In one aspect, the hydrocarbon solvent may include a linear hydrocarbon solvent selected from the group consisting of: dimethyl carbonate (DMC), ethyl methyl carbonate (EMC), diethyl carbonate (DEC), and combinations thereof.

In one aspect, the first salt and the second salt may be independently selected from the group consisting of: lithium hexafluorophosphate (LiPF₆); lithium bis(fluorosulfonyl)imide (LiN(FSO₂)₂) (LiSFI); lithium bis(oxalato)borate (LiB(C₂O₄)₂) (LiBOB); lithium difluorooxalatoborate (LiBF₂(C₂O₄)); lithium perchlorate (LiClO₄); lithium tetrachloroaluminate (LiAlCl₄); lithium iodide (LiI); lithium bromide (LiBr); lithium thiocyanate (LiSCN); lithium tetrafluoroborate (LiBF₄); lithium tetraphenylborate (LiB(C₆H₅)₄); lithium hexafluoroarsenate (LiAsF₆); lithium trifluoromethanesulfonate (LiCF₃SO₃); bis(trifluoromethane)sulfonimide lithium salt (LiN(CF₃SO₂)₂); and combinations thereof. The first salt may have a concentration in the first electrolyte system ranging from about 0.5 M to about 2.5 M, and the second salt may have a concentration in the second electrolyte system ranging from about 0.5 M to about 2.5 M.

In one aspect, the first electrolyte system may be removed from the electrochemical cell by washing the anode with the hydrocarbon solvent at a temperature from about 10° C. to about 40° C.

In one aspect, the fluorinated solvent may have a concentration in the first electrolyte system of greater than about 3 M, and the second electrolyte system may include a residual amount of the fluorinated solvent in an amount less than or equal to about 0.3 M.

In one aspect, cycling may be conducted for between 2 and 7 cycles.

In still other aspects, the present disclosure provides a method of making a negative electrode for an electrochemical cell that cycles lithium ions. The method may include pre-lithiating a negative electrode to produce a pre-lithiated negative electrode; removing the pre-lithiated negative electrode from a first electrochemical cell; and constructing a second electrochemical cell including the pre-lithiated negative electrode and a second electrolyte system. The negative electrode may include a silicon-containing electroactive material. The first electrochemical cell may include the silicon-containing negative electrode and a first electrolyte system. The first electrolyte system may include a fluorinated solvent and a first salt. The fluorinated solvent may have a concentration in the first electrolyte system of greater than 3 M, and the first salt may have a concentration of greater than 0.5 M. The second electrolyte system may include a hydrocarbon solvent and a second salt. The hydrocarbon solvent may have a weight concentration in the second electrolyte system from about 75% to about 95%, and the first salt may have a concentration in the second electrolyte system from about 0.5 M to about 2.5 M.

In one aspect, the method may further include washing the pre-lithiated negative electrode with the hydrocarbon solvent.

In one aspect, the salt in each electrolyte systems may be lithium hexafluorophosphate (LiPF₆), and the hydrocarbon solvent may include ethylene carbonate (EC) and ethyl methyl carbonate (EMC).

In one aspect, the fluorinated solvent may include fluoroethylene carbonate (FEC), dimethyl carbonate (DMC), and difluoroethylene carbonate (DFEC).

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of an exemplary electrochemical battery for purposes of illustration; and

FIG. 2 is a graphical illustration of the capacity retention per cycle of comparative electrochemical cells each comprising a negative electrode including a silicon-containing electroactive material and varying electrolyte systems.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of' or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology pertains to improved electrochemical cells, especially lithium-ion or lithium-metal batteries. The present technology may also be used in other electrochemical devices; especially those that comprise lithium, such as lithium sulfur batteries, so that any discussion of a lithium ion battery is exemplary and non-limiting. In various instances, such cells are used in vehicle applications. However, the present technology may be employed in a wide variety of other applications, as discussed further below.

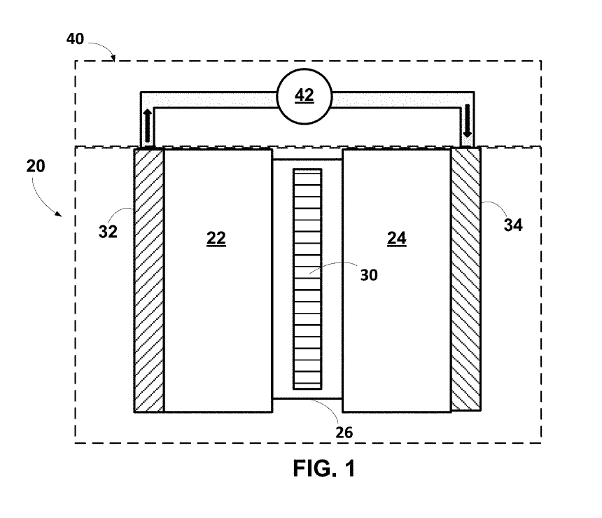

An exemplary and schematic illustration of a battery 20 that cycles lithium ions is shown in FIG. 1. The battery 20 may be a lithium ion electrochemical cell, a lithium sulfur electrochemical cell, or a lithium selenium battery, each including a negative electrode 22, a positive electrode 24, and a porous separator 26 disposed between the two electrodes 22, 24. The porous separator 26 includes an electrolyte system 30, which may also be present in the negative electrode 22 and positive electrode 24. A negative electrode current collector 32 may be positioned at or near the negative electrode 22 and a positive electrode current collector 34 may be positioned at or near the positive electrode 24. The negative electrode current collector 32 and positive electrode current collector 34 respectively collect and move free electrons to and from an external circuit 40. An interruptible external circuit 40 and load device 42 connects the negative electrode 22 (through its current collector 32) and the positive electrode 24 (through its current collector 34).

The porous separator 26 operates as both an electrical insulator and a mechanical support, by being sandwiched between the negative electrode 22 and the positive electrode 24 to prevent physical contact and thus, the occurrence of a short circuit. The porous separator 26, in addition to providing a physical barrier between the two electrodes 22, 24, can provide a minimal resistance path for internal passage of lithium ions (and related anions) during cycling of the lithium ions to facilitate functioning of the battery 20. In lithium ion batteries, lithium intercalates and/or alloys in the electrode active materials. However, in a lithium sulfur battery or a lithium selenium battery, instead of intercalating or alloying, the lithium dissolves from the negative electrode and migrates to the positive electrode where it reacts/plates during discharge, while during charging, lithium plates on the negative electrode.

The battery 20 can be charged or re-energized at any time by connecting an external power source to the battery 20 to reverse the electrochemical reactions that occur during battery discharge. The connection of an external power source to the battery 20 compels the production of electrons and release of lithium ions from the positive electrode 24. The electrons, which flow back towards the negative electrode 22 through the external circuit 40, and the lithium ions, which are carried by the electrolyte system 30 across the separator 26 back towards the negative electrode 22, reunite at the negative electrode 22 and replenish it with lithium for consumption during the next battery discharge cycle. As such, each discharge and charge event is considered to be a cycle, where lithium ions are cycled between the positive electrode 24 and negative electrode 22.

The external power source that may be used to charge the battery 20 may vary depending on the size, construction, and particular end-use of the battery 20. Some notable and exemplary external power sources include, but are not limited to, an AC wall outlet and a motor vehicle alternator. In many lithium-ion battery configurations, lithium sulfur and lithium selenium battery configurations, each of the negative current collector 32, negative electrode 22, the separator 26, positive electrode 24, and positive electrode current collector 34 are prepared as relatively thin layers (for example, from several microns to a millimeter or less in thickness) and assembled in layers connected in electrical parallel arrangement to provide a suitable electrical energy and power package.

Furthermore, the battery 20 can include a variety of other components that while not depicted here are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42.

Accordingly, the battery 20 can generate electric current to a load device 42 that can be operatively connected to the external circuit 40. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances. The load device 42 may also be a power-generating apparatus that charges the battery 20 for purposes of storing energy. In certain other variations, the electrochemical cell may be a supercapacitor, such as a lithium-ion based supercapacitor.

With renewed reference to FIG. 1, the porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP, or multi-layered structured porous films of PE and/or PP. Commercially available polyolefin porous membranes 26 include CELGARD® 2500 (a monolayer polypropylene separator) and CELGARD® 2320 (a trilayer polypropylene/polyethylene/polypropylene separator) available from Celgard LLC.

When the porous separator 26 is a microporous polymeric separator, it may be a single layer or a multi-layer laminate, which may be fabricated from either a dry or wet process. For example, in one embodiment, a single layer of the polyolefin may form the entire microporous polymer separator 26. In other aspects, the separator 26 may be a fibrous membrane having an abundance of pores extending between the opposing surfaces and may have a thickness of less than a millimeter, for example. As another example, however, multiple discrete layers of similar or dissimilar polyolefins may be assembled to form the microporous polymer separator 26. Furthermore, the porous separator 26 may be mixed with a ceramic material or its surface may be coated in a ceramic material. For example, a ceramic coating may include alumina (Al₂O₃), silicon dioxide (SiO₂), or combinations thereof. Various conventionally available polymers and commercial products for forming the separator 26 are contemplated, as well as the many manufacturing methods that may be employed to produce such a microporous polymer separator 26.

In a lithium ion battery, the positive electrode 24 may be formed from a lithium-based active material that can sufficiently undergo lithium intercalation and deintercalation, alloying and dealloying, or plating and stripping, while functioning as the positive terminal of the battery 20. For example, in a lithium-sulfur chalcogen battery, the positive electrode 24 may include sulfur-based compounds as a positive active material. A sulfur-based compound may be selected from at least one of: elemental sulfur, Li₂Sn (wherein n is greater than or equal to 1), Li₂Sn (wherein n is greater than or equal to 1) dissolved in a catholyte, an organosulfur compound, a carbon-sulfur polymer (e.g., (C₂Sₓ)ₙ, where x=2.5 and n is greater than or equal to 2), and combinations thereof. In a lithium-selenium chalcogen battery, the positive electrode 24 may include selenium-based compounds as a positive active material. A selenium-based compound may be selected from one of: elemental selenium, selenium sulfide alloys, and combinations thereof.

In certain variations, the positive active materials may be intermingled with an optional electrically conductive material and at least one polymeric binder material to structurally fortify the positive active material along with an optional electrically conductive particle distributed therein. For example, the active materials and optional conductive materials may be slurry cast with such binders, like polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, lithium alginate. Electrically conductive materials may include graphite, carbon-based materials, powdered nickel, metal particles, or a conductive polymer. Carbon-based materials may include, for example, particles of KETCHEN™ black, DENKA™ black, acetylene black, carbon black, and the like. Examples of a conductive polymer include polyaniline, polythiophene, polyacetylene, polypyrrole, and the like. In certain aspects, mixtures of conductive materials may be used. The positive electrode current collector 34 may be formed from aluminum (Al) or any other appropriate electrically conductive material known to those of skill in the art.

In various aspects, the negative electrode 22 includes an electroactive material as a lithium host material capable of functioning as a negative terminal of a lithium ion battery. In certain aspects, the electroactive material comprises lithium and may be lithium metal. In other aspects, the electroactive material comprises silicon or silicon-containing alloys. The electroactive material of the negative electrode 22 may thus comprise lithium or silicon and may be selected from the group consisting of: lithium metal, silicon metal, silicon-containing alloys, and combinations thereof. For example, lithium-silicon and silicon containing binary and ternary alloys and/or tin-containing alloys include SiSn, SiSnFe, SiSnAl, SiFeCo, SnO₂, and the like. Other silicon active materials include silicon oxides. In certain variations, the negative electrode 22 may optionally include an electrically conductive material, as well as one or more polymeric binder materials to structurally hold the lithium material together. Negative electrodes may comprise greater than about 50% to less than about 100% of an electroactive material (e.g., lithium particles or a lithium foil), optionally less than about 30% of an electrically conductive material, and a balance binder.

For example, in certain instances, the negative electrode 22 may include an active material including graphite, silicon (Si), tin (Sn), or other negative electrode particles intermingled with a binder material selected from the group consisting of: polyvinylidene difluoride (PVDF), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, lithium alginate, polyimide, and combinations thereof. Suitable additional electrically conductive materials may include carbon-based material or a conductive polymer. Carbon-based materials may include for example, particles of KETCHEN™ black, DENKA™ black, acetylene black, carbon black, and the like. Examples of a conductive polymer include polyaniline, polythiophene, polyacetylene, polypyrrole, and the like. In certain aspects, mixtures of conductive materials may be used.

In certain aspects, as further discussed below, the electroactive material of the negative electrode 22 may be pre-lithiated to infuse and/or coat the surface of the electroactive material with lithium to counteract or combat subsequent lithium lost resulting from cell formation and aging. The electroactive material may be pre-lithiated, for example, when the electroactive material comprises silicon metal or a silicon-containing alloy. In various instances, a protective solid electrolyte interface (SEI) layer may be formed over a surface of the negative electrode 22. The protective SEI layer may minimize or prevent continuous electrolyte consumption and lithium ion loss in a manner to prevent charge capacity loss in the battery 20. The protective SEI layer may also, in various instances, suppress or minimize dendrite formation. The negative electrode current collector 32 may be formed from copper (Cu) or any other appropriate electrically conductive material known to those of skill in the art.

In various aspects, the positive electrode 24, the negative electrode 22, and the separator 26 may each include an electrolyte solution or system 30, capable of conducting lithium ions between the negative electrode 22 and the positive electrode 24. The electrolyte system 30 may be a non-aqueous liquid electrolyte solution that includes one or more salts dissolved in a solvent or a mixture of solvents.

As discussed further below, in various instances, the electrolyte system 30 may include fluorinated and/or non-fluorinated salts. For example, the electrolyte system 30 may include one or more salts salt selected from the group consisting of: lithium hexafluorophosphate (LiPF₆); lithium bis(fluorosulfonyl)imide (LiN(FSO₂)₂) (LiSFI); lithium bis(oxalato)borate (LiB(C₂O₄)₂) (LiBOB); lithium difluorooxalatoborate (LiBF₂(C₂O₄)); lithium perchlorate (LiClO₄); lithium tetrachloroaluminate (LiAlCl₄); lithium iodide (LiI); lithium bromide (LiBr); lithium thiocyanate (LiSCN); lithium tetrafluoroborate (LiBF₄); lithium tetraphenylborate (LiB(C₆H₅)₄); lithium hexafluoroarsenate (LiAsF₆); lithium trifluoromethanesulfonate (LiCF₃SO₃); bis(trifluoromethane)sulfonimide lithium salt (LiN(CF₃SO₂)₂); and combinations thereof.

The electrolyte system 30 may include a hydrocarbon-based solvent, such as a cyclic or linear carbonate. For example, in various instances, the electrolyte system 30 may include a linear hydrocarbon solvent selected from the group consisting of: dimethyl carbonate (DMC), ethyl methyl carbonate (EMC), diethyl carbonate (DEC), and combinations thereof; and/or a cyclic hydrocarbon solvent selected from the group consisting of: ethylene carbonate (EC), propylene carbonate (PC), vinylene carbonate (VC), and combinations thereof. Thus, the electrolyte system 30 may include a solvent selected from the group consisting of: ethylene carbonate (EC), propylene carbonate (PC), vinylene carbonate (VC), dimethyl carbonate (DMC), ethyl methyl carbonate (EMC), diethyl carbonate (DEC), and combinations thereof.

In various instances, the electrolyte system 30 may have a salt concentration ranging from about 0.5 M to about 2.5 M, and in certain variations, optionally from about 0.8 M to about 1.2 M. The electrolyte system 30 may include the salt in an amount ranging from about 5 wt % to about 30 wt %, and in certain variations, optionally from about 8 wt % to about 20 wt %. The electrolyte system 30 may include the solvent in an amount ranging from about 70 wt % to about 95 wt %, and in certain variations, optionally from about 80 wt % to about 92 wt %.

In certain instances, the electrolyte system 30 may include a fluorinated solvent in an amount less than about 2 wt %, optionally less than about 1 wt %, optionally less than about 0.5 wt %, and in certain variations, the electrolyte system 30 may be substantially free of a fluorinated solvent. The electrolyte system 30 may include a fluorinated solvent concentration of less than about 0.3 M, optionally less than about 0.22 M, optionally less than about 0.1 M, and in certain variations, the electrolyte system 30 may be substantially free of a fluorinated solvent. The fluorinated solvent may include a cyclic fluorinated solvent selected from the group consisting of: fluoroethylene carbonate (FEC), difluoroethylene carbonate (DFEC), trifluoropropylene carbonate (TFPC), and combinations thereof; and/or a linear fluorinated solvent selected from the group consisting of: methyl 2,2,2-trifluoroethyl carbonate, ethyl 2,2,2-trifluoroethyl carbonate, 2,2-difluoroethyl methyl carbonate, 2,2-difluoroethyl ethyl carbonate, 2,2-difluoroethylacetate, 2,2,2-trifluoroethylacetate, 1,1,2,2-tatrafluoroethyl 2,2,3,3-tetrafluoropropylether, and combinations thereof. Thus, the fluorinated solvent may include a solvent selected from the group consisting of fluoroethylene carbonate (FEC), difluoroethylene carbonate (DFEC), trifluoropropylene carbonate (TFPC), methyl 2,2,2-trifluoroethyl carbonate, ethyl 2,2,2-trifluoroethyl carbonate, 2,2-difluoroethyl methyl carbonate, 2,2-difluoroethyl ethyl carbonate, 2,2-difluoroethylacetate, 2,2,2-trifluoroethylacetate, 1,1,2,2-tatrafluoroethyl 2,2,3,3-tetrafluoropropylether, and combinations thereof.

In various instances, the electrolyte system 30 may include an electrolyte additive. In certain instances, the electrolyte additive may be selected from the group consisting of: vinylene carbonate (VC); vinyl ethylene carbonate (VEC); 1,3-propanesultone (1,3-PS); 1,4-butanesultone (BS); methylene methane disulfonate (MMDS); tris(-trimethyl-silyl)-phosphate (TTSP); and combinations thereof.

In certain aspects, the present disclosure provides an electrochemical cell (e.g., battery 20) including (i) lithiated anodes (e.g., negative electrode 22) comprising a silicon-containing electroactive material and (ii) an electrolyte system (e.g., electrolyte system 30) comprising a hydrocarbon solvent and a salt. In various aspects, the present disclosure provides methods of making such an electrochemical cell (e.g., battery 20) having improved electrochemical performance and reduced or minimized gassing. As discussed further below, the method may include (i) forming a first electrochemical cell having a negative electrode and a first electrolyte system; (ii) pre-lithiating the negative electrode; and (iii) forming a second electrochemical cell, where the second electrochemical cell contains the lithiated negative electrode and a second electrolyte system (e.g., electrolyte system 30).

In various instances, the first electrochemical cell includes a negative electrode comprising a silicon-containing electroactive material and a first electrolyte system. The first electrolyte system comprises a first solvent and a first salt. The first solvent may be a fluorinated solvent. The fluorinated solvent may be particularly suited to cause the formation of a protective solid electrolyte interface (SEI) layer. In certain instances, the solid electrolyte interface (SEI) layer may comprise primarily lithium fluoride (LiF) that is imbedded in a polymer network in a manner to accommodate volumetric changes within the negative electrode, such as when the negative electrode comprises a silicon-containing electroactive material.

The fluorinated solvent may include linear and/or cyclic solvents. For example, the fluorinated solvent may include a cyclic fluorinated solvent selected from the group consisting of: fluoroethylene carbonate (FEC), difluoroethylene carbonate (DFEC), trifluoropropylene carbonate (TFPC), and combinations thereof; and/or a linear fluorinated solvent selected from the group consisting of: methyl 2,2,2-trifluoroethyl carbonate, ethyl 2,2,2-trifluoroethyl carbonate, 2,2-difluoroethyl methyl carbonate, 2,2-difluoroethyl ethyl carbonate, 2,2-difluoroethylacetate, 2,2,2-trifluoroethylacetate, 1,1,2,2-tatrafluoroethyl 2,2,3,3-tetrafluoropropylether, and combinations thereof. Thus, the fluorinated solvent may include a solvent selected from the group consisting of fluoroethylene carbonate (FEC), difluoroethylene carbonate (DFEC), trifluoropropylene carbonate (TFPC), methyl 2,2,2-trifluoroethyl carbonate, ethyl 2,2,2-trifluoroethyl carbonate, 2,2-difluoroethyl methyl carbonate, 2,2-difluoroethyl ethyl carbonate, 2,2-difluoroethylacetate, 2,2,2-trifluoroethylacetate, 1,1,2,2-tatrafluoroethyl 2,2,3,3-tetrafluoropropylether, and combinations thereof.

The first electrolyte system may include the fluorinated solvent in an amount greater than about 5 wt %, optionally greater than about 10 wt %, optionally greater than about 20 wt %, and in certain variations, optionally greater than about 30 wt %. The first electrolyte system may include a fluorinated solvent concentration of greater than 0.6 M, optionally greater than about 1 M, optionally greater than about 2 M, optionally greater than about 3 M, and in certain variations, optionally greater than about 3.3 M. Higher concentrations, or weight percentages, of the fluorinated solvent may improve the quality of a formed protective solid electrolyte interface (SEI) layer.

The first salt may be selected from the group consisting of: lithium hexafluorophosphate (LiPF₆); lithium bis(fluorosulfonyl)imide (LiN(FSO₂)₂) (LiSFI); lithium bis(oxalato)borate (LiB(C₂O₄)₂) (LiBOB); lithium difluorooxalatoborate (LiBF₂(C₂O₄)); lithium perchlorate (LiClO₄); lithium tetrachloroaluminate (LiAlCl₄); lithium iodide (LiI); lithium bromide (LiBr); lithium thiocyanate (LiSCN); lithium tetrafluoroborate (LiBF₄); lithium tetraphenylborate (LiB(C₆H₅)₄); lithium hexafluoroarsenate (LiAsF₆); lithium trifluoromethanesulfonate (LiCF₃SO₃); bis(trifluoromethane)sulfonimide lithium salt (LiN(CF₃SO₂)₂); and combinations thereof. The first electrolyte system may include the first salt in an amount ranging from about 5 wt % to about 30 wt %, and in certain variations, optionally from about 8 wt % to about 20 wt %. The first electrolyte system may include a first salt concentration ranging from about 0.5 M to about 2.5 M, and in certain variations, optionally from about 0.8 M to about 1.2 M.

In various instances, the second electrochemical cell includes the negative electrode comprising the silicon-containing electroactive material and a second electrolyte system. The second electrolyte system comprises a second solvent and a second salt. The second solvent may be a non-fluorinated solvent. In various instances, the non-fluorinated solvent may be a hydrocarbon solvent. The hydrocarbon solvent may include linear and/or cyclic solvents. For example, the electrolyte system 30 may include a linear hydrocarbon solvent selected from the group consisting of: dimethyl carbonate (DMC), ethyl methyl carbonate (EMC), diethyl carbonate (DEC), and combinations thereof; and/or a cyclic hydrocarbon solvent selected from the group consisting of: ethylene carbonate (EC), propylene carbonate (PC), vinylene carbonate (VC), and combinations thereof. Thus, the electrolyte system may include a solvent selected from the group consisting of: ethylene carbonate (EC), propylene carbonate (PC), vinylene carbonate (VC), dimethyl carbonate (DMC), ethyl methyl carbonate (EMC), diethyl carbonate (DEC), and combinations thereof.

In various instances, the second salt may be selected from the group consisting of: lithium hexafluorophosphate (LiPF₆); lithium bis(fluorosulfonyl)imide (LiN(FSO₂)₂) (LiSFI); lithium bis(oxalato)borate (LiB(C₂O₄)₂) (LiBOB); lithium difluorooxalatoborate (LiBF₂(C₂O₄)); lithium perchlorate (LiClO₄); lithium tetrachloroaluminate (LiAlCl₄); lithium iodide (LiI); lithium bromide (LiBr); lithium thiocyanate (LiSCN); lithium tetrafluoroborate (LiBF₄); lithium tetraphenylborate (LiB(C₆H₅)₄); lithium hexafluoroarsenate (LiAsF₆); lithium trifluoromethanesulfonate (LiCF₃SO₃); bis(trifluoromethane) sulfonimide lithium salt (LiN(CF₃SO₂)₂); and combinations thereof. In certain variations, the second salt may be the same as the first salt.

The second electrolyte system may include the hydrocarbon solvent in an amount ranging from about 75 wt % to about 95 wt %, and in certain variations, optionally from about 80 wt % to about 90 wt %. The second electrolyte system may include the salt in an amount ranging from about 5 wt % to about 30 wt %, and in certain variations, optionally from about 8 wt % to about 20 wt %. The second electrolyte system may include a salt concentration ranging from about 0.5 M to about 2.5 M, and in certain variations, optionally from about 0.8 M to about 1.2 M.

As mentioned above, the present disclosure provides a method of making an electrochemical cell that cycles lithium ions and comprises a silicon-containing anode. The method may comprise forming a first electrochemical cell, pre-lithiating a negative electrode contained therewithin, and forming a second electrochemical cell, where the second electrochemical cell contains the lithiated negative electrode. More particularly, the method may comprise first, forming a first electrochemical cell comprising a silicon-containing anode and a first electrolyte system, where the first electrolyte system comprises a fluorinated solvent and a first salt, and the fluorinated solvent is present in the first electrolyte system in an amount greater than about 5 wt %. Second, pre-lithiating the silicon-containing anode to produce a pre-lithiated anode in the first electrochemical cell; and third, forming a second electrochemical cell comprising the pre-lithiated anode and a second electrolyte system, where the second electrolyte system comprise a non-fluorinated solvent, such as a hydrocarbon solvent, and a second salt.

In various instances, pre-lithiating the silicon-containing anode to produce the pre-lithiated anode in the first electrochemical cell may include cycling the first electrochemical cell. At least one cycle of the first electrochemical cell including the first electrolyte system is conducted to pre-lithiate the negative electrode and/or form a protective solid electrolyte interface (SEI) layer. In certain instances, cycling of the first electrochemical cell is conducted, however, for from 2 to 7 cycles, and in certain instances, optionally, from 2 to 5 cycles, to pre-lithiate the negative electrode. In various other instances, pre-lithiating the silicon-containing anode to produce the pre-lithiated anode in the first electrochemical cell may include disposing lithium metal onto one or more surfaces of the silicon-containing anode.

In various instances, forming the second electrochemical cell comprises removing, or emptying, the first electrolyte system from the first electrochemical cell, for example, following pre-lithiating of the silicon-containing anode, and introducing the second electrolyte to the emptied first electrochemical cell. In various other instances, forming the second electrochemical cell comprises removing the pre-lithiated anode from the first electrochemical cell, and constructing the second electrochemical cell with the pre-lithiated anode and the second electrolyte system.

In various instances, the method may further include washing the first electrochemical cell and/or the pre-lithiated anode. For example, in certain variations, the lithiated anode may be cleaned, for example, by being washing at a temperature ranging from about 10° C. to about 40° C. prior to and/or after removal from the first electrochemical cell and prior to inclusion in, or construction of, the second electrochemical cell. In various other instances, the electrochemical cell including the pre-lithiated anode may be cleaned, for example, by being washing at a temperature ranging from about 10° C. to about 40° C. prior to and/or after removal of the first electrolyte system and/or during the addition, or inclusion, of the second electrolyte system.

In various instances, the first electrochemical cell and/or the pre-lithiated anode may be washed using the hydrocarbon solvent of the second electrolyte system. Washing the first electrochemical cell and/or the pre-lithiated anode may minimize or reduce a residual amount of the first electrolyte system, in particular, the fluorinated solvent. For example, the second electrochemical cell may further include the fluorinated solvent in an amount less than about 2 wt %, optionally less than about 1 wt %, optionally less than about 0.5 wt %, and in certain variations, the second electrochemical cell may be substantially free of a fluorinated solvent. The second electrochemical cell may include a fluorinated solvent concentration of less than about 0.3 M, optionally less than about 0.22 M, optionally less than about 0.1 M, and in certain variations, the second electrochemical cell may be substantially free of a fluorinated solvent.

In this fashion, the concentration of the fluorinated solvent of the second electrolyte system, and thereby of the second electrochemical cell, is reduced or minimized, reducing the potential occurrence of negative side reactions resulting in gaseous side products, including for example hydrogen and/or carbon dioxide, that many hinder long term cycling of the second electrochemical cell, while maintaining the benefits of the protective solid electrolyte interface (SEI) induced or formed by the fluorinated solvent. Such gaseous side reactions occurring in instances of high concentrations of a fluorinated solvent may be particularly problematic in the instances of pouch cells.

In various instances, the first electrochemical cell may include a first cathode and/or cell structures, and the second electrochemical may include a second cathode and/or cell structures. The first and second cathodes may have the same or similar composition and structure. In various other instances, however, the second electrochemical cell may include the first cathode and/or cell structures.

Embodiments of the present technology are further illustrated through the following non-limiting examples.

### EXAMPLE 1

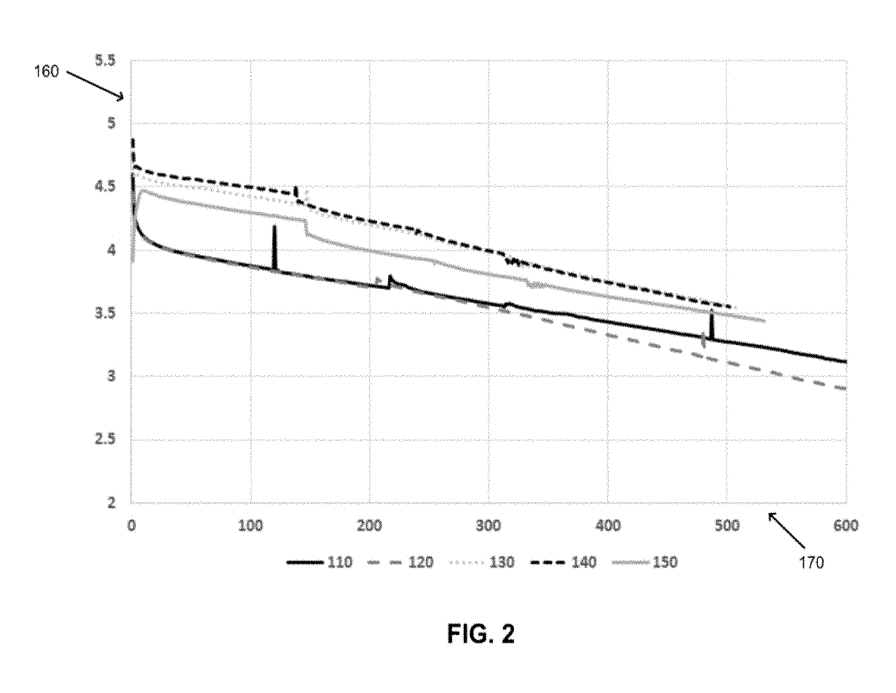

FIG. 2 shows the charging and discharging profiles of comparative electrochemical cells 110, 120, 130, 140, and 150 each including a negative electrode comprising a silicon-containing electroactive material and varying electrolyte systems. The y-axis 160 depicts the capacity retention in milliamp hour (mAh), while the cycle number is shown on the x-axis 170.

Electrochemical cell 110 includes a baseline electrolyte system comprising lithium hexafluorophosphate (LiPF₆) salt and co-solvents fluoroethylene carbonate (FEC) and dimethyl carbonate (DMC). Electrochemical cell 120 includes another baseline electrolyte system comprising lithium hexafluorophosphate (LiPF₆) salt and co-solvents fluoroethylene carbonate (FEC), dimethyl carbonate (DMC), and methyl (2,2,2-trifluoroethyl) carbonate (FEMC).

Electrochemical cells 130, 140, and 150 were prepared in accordance with certain aspects of the present disclosure. In particular, for each electrochemical cells 130, 140, and 150, the method included forming a first electrochemical cell having a first electrolyte system, pre-lithiating a negative electrode contained therewithin, and forming the second electrochemical cell (e.g., electrochemical cells 130, 140, and 150), where the second electrochemical cell contains the lithiated negative electrode and a second electrolyte system.

The first electrolyte system used to form electrochemical cell 130 comprised lithium hexafluorophosphate (LiPF₆) salt and co-solvents fluoroethylene carbonate (FEC) and dimethyl carbonate (DMC). The second electrolyte system of electrochemical cell 130 includes lithium hexafluorophosphate (LiPF₆) salt and non-fluorinated co-solvents ethylene carbonate (EC) and ethyl methyl carbonate (EMC).

The first electrolyte system used to form electrochemical cell 140 comprised lithium hexafluorophosphate (LiPF₆) salt and co-solvents ethylene carbonate (EC), ethyl methyl carbonate (EMC), and fluoroethylene carbonate (FEC). The second electrolyte system of electrochemical cell 140 includes lithium hexafluorophosphate (LiPF₆) salt and non-fluorinated co-solvents ethylene carbonate (EC) and ethyl methyl carbonate (EMC).

The first electrolyte system used to form electrochemical cell 50 comprised lithium hexafluorophosphate (LiPF₆) salt and co-solvents fluoroethylene carbonate (FEC), dimethyl carbonate (DMC), and difluoroethylene carbonate (DFEC). The second electrolyte system of electrochemical cell 150 includes lithium hexafluorophosphate (LiPF₆) salt and non-fluorinated co-solvents ethylene carbonate (EC) and ethyl methyl carbonate (EMC).

As seen electrochemical cells 130, 140, and 150 have improved long-term performance over electrochemical cells 110 and 120. More particularly, electrochemical cells 130, 140, and 150 have superior long-term stability over 500 cycles. Electrochemical cells 110 and 120, not including a pre-lithiated negative electrode, show about 15% lower capacity than electrochemical cells 130, 140, and 150. Accordingly, electrochemical cells 130, 140, and 150 prepared in accordance with certain aspects of the present disclosure, have improved cycling performance and reduced capacity fade.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for making an electrochemical cell that cycles lithium ions, the electrochemical cell comprising a silicon-containing anode, the method comprising:
forming a first electrochemical cell comprising the silicon-containing anode and a first electrolyte system, wherein the first electrolyte system comprises a fluorinated solvent and a first salt, wherein the fluorinated solvent is present in the first electrolyte system in an amount greater than about 5 wt %;
pre-lithiating the silicon-containing anode to produce a pre-lithiated anode in the first electrochemical cell; and
forming a second electrochemical cell comprising the pre-lithiated anode and a second electrolyte system, wherein the second electrolyte system comprises a hydrocarbon solvent and a second salt.

2. The method of claim 1, wherein forming the second electrochemical cell comprises removing the first electrolyte system from the first electrochemical cell and introducing the second electrolyte into the emptied first electrochemical cell.

3. The method of claim 1, wherein forming the second electrochemical cell comprises removing the pre-lithiated anode from the first electrochemical cell and constructing the second electrochemical cell with the pre-lithiated anode and the second electrolyte system.

4. The method of claim 1, wherein the method further includes washing the pre-lithiated anode with the hydrocarbon solvent.

5. The method of claim 4, wherein the second electrolyte system includes a residual amount of the fluorinated solvent in an amount less than or equal to about 2 wt %.

6. The method of claim 1, wherein the fluorinated solvent comprises a solvent selected from the group consisting of: fluoroethylene carbonate (FEC), difluoroethylene carbonate (DFEC), trifluoropropylene carbonate (TFPC), methyl 2,2,2-trifluoroethyl carbonate, ethyl 2,2,2-trifluoroethyl carbonate, 2,2-difluoroethyl methyl carbonate, 2,2-difluoroethyl ethyl carbonate, 2,2-difluoroethylacetate, 2,2,2-trifluoroethylacetate, 1,1,2,2-tatrafluoroethyl 2,2,3,3-tetrafluoropropylether, and combinations thereof; and
wherein the hydrocarbon solvent comprises a solvent selected from the group consisting of: ethylene carbonate (EC), propylene carbonate (PC), vinylene carbonate (VC), dimethyl carbonate (DMC), ethyl methyl carbonate (EMC), diethyl carbonate (DEC), and combinations thereof,
wherein the first salt and the second salt are independently selected from the group consisting of: lithium hexafluorophosphate (LiPF₆); lithium bis(fluorosulfonyl)imide (LiN(FSO₂)₂) (LiSFI); lithium bis(oxalato)borate (LiB(C₂O₄)₂) (LiBOB); lithium difluorooxalatoborate (LiBF₂(C₂O₄)); lithium perchlorate (LiClO₄); lithium tetrachloroaluminate (LiAlCl₄); lithium iodide (LiI); lithium bromide (LiBr); lithium thiocyanate (LiSCN); lithium tetrafluoroborate (LiBF₄); lithium tetraphenylborate (LiB(C₆H₅)₄); lithium hexafluoroarsenate (LiAsF₆); lithium trifluoromethanesulfonate (LiCF₃SO₃); bis(trifluoromethane)sulfonimide lithium salt (LiN(CF₃SO₂)₂); and combinations thereof.

7. The method of claim 1, wherein the second electrochemical cell has a Coulombic capacity loss of about 25% after about 500 cycles.

8. A method of making an electrochemical cell that cycles lithium ions, the electrochemical cell comprising an anode including a silicon-containing electroactive material, the method comprising:
introducing a first electrolyte system into the electrochemical cell, the first electrolyte system comprising a fluorinated solvent and a first salt, wherein the fluorinated solvent has a concentration in the first electrolyte system of greater than about 0.6 M;
cycling the electrochemical cell to pre-lithiate the anode;
removing the first electrolyte system from the electrochemical cell; and
introducing a second electrolyte system into the electrochemical cell, the second electrolyte system comprising a hydrocarbon solvent and a second salt.

9. The method of claim 8, wherein the fluorinated solvent includes a cyclic fluorinated solvent selected from the group consisting of: fluoroethylene carbonate (FEC), difluoroethylene carbonate (DFEC), trifluoropropylene carbonate (TFPC), and combinations thereof.

10. The method of claim 9, wherein the fluorinated solvent further includes a linear fluorinated solvent selected from the group consisting of: methyl 2,2,2-trifluoroethyl carbonate, ethyl 2,2,2-trifluoroethyl carbonate, 2,2-difluoroethyl methyl carbonate, 2,2-difluoroethyl ethyl carbonate, 2,2-difluoroethylacetate, 2,2,2-trifluoroethylacetate, 1,1,2,2-tatrafluoroethyl 2,2,3,3-tetrafluoropropylether, and combinations thereof.

11. The method of claim 8, wherein the hydrocarbon solvent includes a cyclic hydrocarbon solvent selected from the group consisting of: ethylene carbonate (EC), propylene carbonate (PC), vinylene carbonate (VC), and combinations thereof.

12. The method of claim 11, wherein the hydrocarbon solvent further includes a linear hydrocarbon solvent selected from the group consisting of: dimethyl carbonate (DMC), ethyl methyl carbonate (EMC), diethyl carbonate (DEC), and combinations thereof.

13. The method of claim 8, wherein the first salt and second salt are independently selected from the group consisting of: lithium hexafluorophosphate (LiPF₆); lithium bis(fluorosulfonyl)imide (LiN(FSO₂)₂) (LiSFI); lithium bis(oxalato)borate (LiB(C₂O₄)₂) (LiBOB); lithium difluorooxalatoborate (LiBF₂(C₂O₄)); lithium perchlorate (LiClO₄); lithium tetrachloroaluminate (LiAlCl₄); lithium iodide (LiI); lithium bromide (LiBr); lithium thiocyanate (LiSCN); lithium tetrafluoroborate (LiBF₄); lithium tetraphenylborate (LiB(C₆H₅)₄); lithium hexafluoroarsenate (LiAsF₆); lithium trifluoromethanesulfonate (LiCF₃SO₃); bis(trifluoromethane)sulfonimide lithium salt (LiN(CF₃SO₂)₂); and combinations thereof; and wherein the first salt has a concentration in the first electrolyte system ranging from about 0.5 M to about 2.5 M, and the second salt has a concentration in the second electrolyte system ranging from about 0.5 M to about 2.5 M.

14. The method of claim 8, wherein the first electrolyte system is removed from the electrochemical cell by washing the anode with the hydrocarbon solvent at a temperature from about 10° C. to about 40° C.

15. The method of claim 14, wherein the fluorinated solvent has a concentration in the first electrolyte system of greater than about 3 M, and the second electrolyte system includes a residual amount of the fluorinated solvent in an amount less than or equal to about 0.3 M.

16. The method of claim 8, wherein the cycling is conducted from 2 to 7 cycles.

17. A method of making a negative electrode for an electrochemical cell that cycles lithium ions, the method comprising:
pre-lithiating a negative electrode to produce a pre-lithiated negative electrode, wherein the negative electrode comprises a silicon-containing electroactive material and a first electrochemical cell comprises the negative electrode and a first electrolyte system, wherein the first electrolyte system comprises a fluorinated solvent and a first salt, and wherein the fluorinated solvent has a concentration in the first electrolyte system of greater than 3 M and the first salt has a concentration in the first electrolyte system of greater than 0.5 M;
removing the pre-lithiated negative electrode from the first electrochemical cell; and
constructing a second electrochemical cell, wherein the electrochemical cell comprises the pre-lithiated negative electrode and a second electrolyte system, wherein the second electrolyte system comprises a hydrocarbon solvent and a second salt, wherein the hydrocarbon solvent has a weight concentration in the second electrolyte system from about 75% to about 95% and the first salt has a concentration in the second electrolyte system from about 0.5 M to about 2.5 M.

18. The method of claim 17, wherein the method further includes washing the pre-lithiated negative electrode with the hydrocarbon solvent.

19. The method of claim 17, wherein the salt in each electrolyte systems is lithium hexafluorophosphate (LiPF₆), and the hydrocarbon solvent includes ethylene carbonate (EC) and ethyl methyl carbonate (EMC).

20. The method of claim 19, wherein the fluorinated solvent includes fluoroethylene carbonate (FEC), dimethyl carbonate (DMC), and difluoroethylene carbonate (DFEC).
